(19) United States
(12) Patent Application Publication
(10) Pub. No.: US 2026/0205400 A1
(43) Pub. Date: Jul. 16, 2026

(54) AUTOMATED MONITORING AND RECOVERY OF INTERNET OF THINGS (IOT) DEVICES

(71) Applicant: Target Brands, Inc., Minneapolis, MN (US)

(72) Inventors: Michael Christopher Beckel, Anoka, MN (US); Kent Myron Vareberg, Chaska, MN (US)

(21) Appl. No.: 19/018,749

(22) Filed: Jan. 13, 2025

(51) Int. Cl. H04L 43/10; G16Y 10/75; G16Y 20/20; G16Y 40/20; H04N 7/18; H04N 17/00; H04N 23/661

(52) U.S. Cl. CPC H04L 43/10; H04N 7/183; H04N 17/002; H04N 23/661; G16Y 10/75; G16Y 20/20; G16Y 40/20

(57) ABSTRACT

In some implementations, a method is provided for automatically monitoring and recovering internet of things (IoT) devices on a network. An automated heartbeat operation is performed for determining responsiveness of a device over the network. In response to the automated heartbeat operation resulting in a determination that the device is unresponsive over the network, an automated recovery operation of the device is performed. A restart command is transmitted for restarting the device. After transmitting the restarting command for restarting the device, the automated recovery operation waits for a restart period to elapse. After the restart period has elapsed, a test for determining whether the device is operational is automatically performed. A recovery event that indicates failure or success of the test for determining whether the device is operational is transmitted to an event data store.

### TECHNICAL FIELD

This specification generally relates to a platform for performing automated monitoring and recovery of Internet of Things (IoT) devices across a computer network.

### BACKGROUND

Configuration tools can be used to configure and manage devices on a computer network. Network administrators can use such tools to scan a network for connected devices, and to manually configure and manage devices that are found during the network scan (e.g., through a graphical user interface). Device data can be exported to and employed by various device management utilities.

### SUMMARY

This document generally describes computer systems, processes, program products, and devices for automatically monitoring and recovering internet of things (IoT) devices, such as physical sensors (e.g., including security cameras and/or other sorts of sensors), output devices, control devices, robotic devices, appliances, etc., across a computer network. In general, an enterprise may employ a vast number of devices across its facilities, including various different models from various different vendors, with each model possibly having different features and using different communications protocols. Further, the enterprise's fleet of devices may include a significant number of legacy devices, which can be unstable and challenging to maintain.

The solution facilitated by the presently described technology provides a device service platform for automatically managing devices (e.g., security cameras and/or other devices) in an enterprise environment, across the enterprise's facilities. The device service platform decouples the management of devices from enterprise applications that are configured to interface with the devices, while improving the security posture of the devices. The device service platform is hardware agnostic, in that devices of different models and vendors can be interchanged without having to refactor the enterprise applications. Management of the devices can be performed automatically by the device service platform (e.g., under a plug and play model), and the devices can easily by leveraged by new applications.

Briefly, the device service platform involves firmware, protocols, and a system architecture for permitting different devices (e.g., security cameras and/or other devices) to interface as part of the platform, including processes for automatically monitoring and recovering the devices in the event of network disconnection and/or device failure. A monitoring operation includes a periodically performed heartbeat detection process for determining responsiveness of the devices over a network. When a device is found to be unresponsive, the device service platform launches an automated recovery operation for attempting to recover the device. The automated recovery operation includes transmitting a restart command to the device, waiting for a restart period to elapse, and checking again for device responsiveness. If the device is found to be responsive after restarting, a series of checks and a possible reconfiguration is automatically performed on the device. After performing the recovery operation for the device, a corresponding recovery event is saved to an event data store for future processing and analysis. Optionally, machine learning techniques can be used to identify possible issues with the devices and/or network, and an action alert can be generated for reconfiguring a system that includes the devices.

In some implementations, a method for automatically monitoring and recovering internet of things (IoT) devices on a network includes performing an automated heartbeat operation for determining responsiveness of a device over the network; in response to the automated heartbeat operation resulting in a determination that the device is unresponsive over the network, performing an automated recovery operation of the device, the automated recovery operation including: transmitting a restart command for restarting the device; after transmitting the restarting command for restarting the device, waiting for a restart period to elapse; after the restart period has elapsed, automatically performing a test for determining whether the device is operational; and transmitting, to an event data store, a recovery event that indicates failure or success of the test for determining whether the device is operational.

Other implementations of this aspect include corresponding computer systems, and include corresponding apparatus and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other implementations can include any, all, or none of the following features. The device can be a security camera. The event data store can be an event streaming platform. The automated heartbeat operation can include performing a primary heartbeat check of the device over the network. In response to determining that the device is unresponsive over the network during the primary heartbeat check, an unresponsiveness timer can be started for the device. After starting the unresponsiveness timer, at least one secondary heartbeat check of the device can be performed over the network. In response to determining that the device has remained unresponsive during the at least one secondary heartbeat check, and determining that the unresponsiveness timer has elapsed, a determination can be made that the device is unresponsive over the network. Performing the at least one secondary heartbeat check can include performing the secondary heartbeat check in response to determining that the unresponsiveness timer has elapsed. Performing the at least one secondary heartbeat check can include periodically performing the secondary heartbeat check while the unresponsiveness timer is running. A protocol for performing the primary heartbeat check can be a same protocol as a protocol for performing the at least one secondary heartbeat check. A protocol for performing the primary heartbeat check can be a different protocol from a protocol for performing the at least one secondary heartbeat check. After the restart period has elapsed, an automatic determination can be performed of whether a configuration of the device is correct. In response to determining that the configuration of the device is incorrect, the device can be automatically reconfigured. The test for determining whether the device is operational can be performed after reconfiguring the device. Determining whether the configuration of the device is correct can include executing a configuration settings collection process that collects current configuration settings of the device. Preferred configuration settings that have been specified for the device can be received from a configuration data store. The current configuration settings of the device can be compared to the preferred configuration settings. Automatically reconfiguring the device can include executing a configuration settings application process that applies the preferred configuration settings to the device. Performing the test for determining whether the device is operational can include interfacing with an application programming interface (API) of the device. A command can be issued via the API to perform a video streaming operation. An indication can be received via the API that the video streaming operation was successful. The test for determining whether the device is operational can result in a determination that the device is non-operational. In response to determining that the device is non-operational, a determination can be performed of whether a recovery limit for the device has been reached. The recovery event can indicate failure of the test for determining whether the device is operational. In response to determining that the recovery limit for the device had not been reached, a factory reset of the device can be automatically performed, and the device can be automatically reconfigured. Event data that pertains to a plurality of IoT devices on the network can be received from the event data store. The event data can be used to train a machine learning model. Based on an output of the machine learning model, an action alert can be generated for reconfiguring a system that includes the plurality of IoT devices.

The systems, devices, program products, and processes described throughout this document can, in some instances, provide one or more of the following advantages. Automated monitoring and recovering operations can be performed at appropriate times and without employing manually-driven processes. By executing a heartbeat detection process as a localized service for monitoring devices, network traffic can be reduced for an enterprise across a wide area network (WAN) and/or the Internet, while providing current device data for devices of a facility to downstream processes. By waiting for an unresponsiveness timer to elapse during the heartbeat detection process, scenarios can be accounted for in which a device is temporarily disconnected from the network but is otherwise operational. An automated configuration operation can be executed to rectify configuration drift, thereby improving a device's security posture, and improving the ability to integrate the device into various enterprise operations. Recovery limits can be checked while performing recovery operations to prevent infinite process loops, and to identify particular devices, switches, or local area networks that may be experiencing broader problems that can benefit from additional investigation. Data patterns can be identified that link particular devices, device models, switches, and/or networks to an elevated frequency of device failure, and appropriate actions can be determined to improve the stability and supportability of devices across a network.

Other features, aspects and potential advantages will be apparent from the accompanying description and figures.

### DESCRIPTION OF DRAWINGS

FIG. 1 depicts an example system for performing automated monitoring and recovery of Internet of Things (IoT) devices across a computer network.

FIGS. 2A-2D depict an example illustrative process for performing automated monitoring and recovery of Internet of Things (IoT) devices across a computer network.

FIG. 3 is a flow diagram of an example technique for processing and maintaining events related to Internet of Things (IoT) devices.

FIG. 4 is a flow diagram of an example technique for monitoring and for triggering recovery operations for Internet of Things (IoT) devices.

FIG. 5 is a flow diagram of an example technique for performing recovery operations for Internet of Things (IoT) devices.

FIG. 6 is a flow diagram of an example technique for transmitting commands to Internet of Things (IoT) devices, and for generating associated events.

FIG. 7 is a flow diagram of an example technique for performing automated configuration of Internet of Things (IoT) devices.

FIG. 8 is a schematic diagram that shows an example of a computing system.

Like reference symbols in the various drawings indicate like elements.

### DETAILED DESCRIPTION

This document describes technology that can perform automated monitoring and recovery of Internet of Things (IoT) devices across a computer network. In general, a device service platform facilitates processes for automatically monitoring, recovering, and managing the devices (e.g., security cameras and/or other types of IoT devices) in the event of network disconnection and/or device failure. A monitoring operation includes a periodically performed heartbeat detection process for determining responsiveness of the devices over a network. When a device is found to be unresponsive, an automated recovery operation is launched for attempting to recover the device. The automated recovery operation includes transmitting a restart command to the device, waiting for a restart period to elapse, and checking again for device responsiveness. If the device is found to be responsive after restarting, a series of checks and a possible device reconfiguration is automatically performed. Further, machine learning techniques can optionally be used to identify possible issues with the devices and/or network (e.g., based on aggregated event data that is maintained for the IoT devices), and an action alert can be generated for reconfiguring a system that includes the devices.

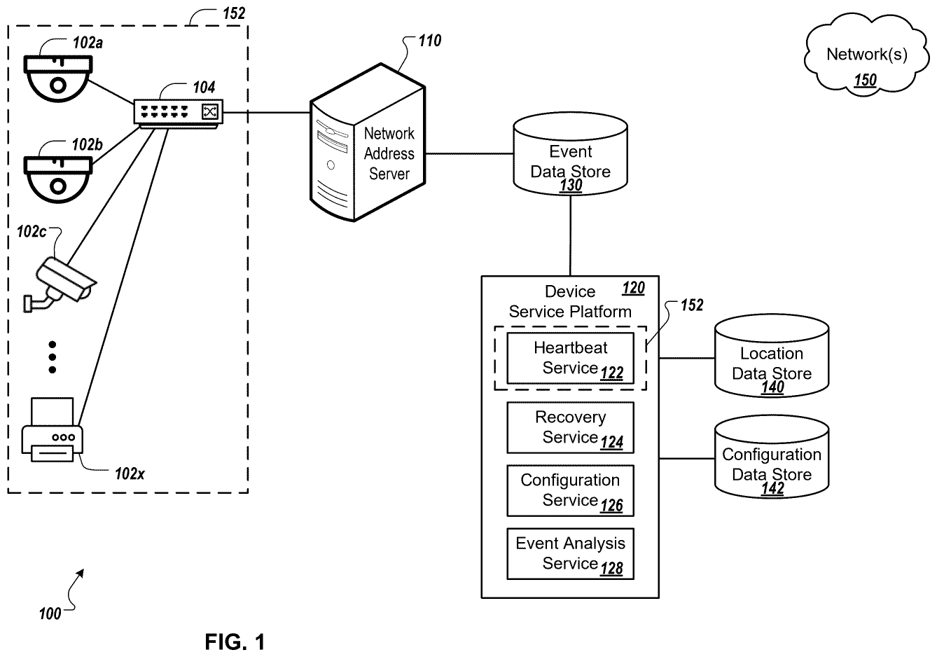

FIG. 1 depicts an example system 100 for performing automated monitoring and recovery of Internet of Things (IoT) devices across a computer network. In general, the system 100 can include various computing devices, computing server systems, and data stores, configured to communicate with each other over one or more networks. For example, the system 100 can include various Internet of Things (IoT) devices (e.g., devices 102a, 102b, 102c, 102x, etc.), various network switches and/or routers (e.g., switch/router 104), a network address server 110 (e.g., a Dynamic Host Configuration Protocol (DHCP) server, or another sort of server that is configured to assign network addresses (e.g., Internet Protocol (IP) addresses) to client devices), a device service platform 120, various data stores (e.g., event data store 130, location data store 140, and configuration data store 142), that can communicate and exchange data over networks 150 and 152 (e.g., including one or more LANs (local area networks), WANs (wide area networks), and/or the Internet).

The Internet of Things (IoT) devices 102a-x, for example, can represent various sorts of devices that can be individually addressable on a network, that can be connected to the network, and that can send and receive data over the network. For example, the IoT devices 102a-x can include various sorts of physical sensors (e.g., motion sensors, temperature sensors, sound sensors, light sensors, cameras, etc.), various sorts of output devices (e.g., speakers, lighting units, displays, printers, etc.), control devices, robotic devices, appliances, and so forth. In general, an entity (e.g., an individual, an organization, etc.) can manage a network that possibly includes multiple different types of IoT devices, with some devices possibly being different instances of a same device model. In the present example, device 102a and 102b each represent different instances of a same model of security video camera (e.g., “Model N”), device 102c represents an instance of a different model of security video camera (e.g., “Model O”), and device 102x represent an instance of another type of IoT device (e.g., a terminal, a display, a printer, or another sort of non-camera device).

The switch/router 104, for example, can handle communications between the devices 102a-x, the network address server 110, and the device service platform 120, over the networks 150 and 152. A switch, for example, can be configured to forward data packets between the devices 102a-x and other devices on the network 152 (e.g., a local area network (LAN)). A router, for example, can be configured to forward data packets between the devices 102a-x and other devices on the network 150 (e.g., a wide area network (WAN) and/or the Internet). Forwarding data packets can be performed by the switch/router 104, for example, based on a Media Access Control (MAC) address and/or an Internet Protocol (IP) address of a destination device.

The network address server 110, for example, can represent a server that is configured to assign network addresses and other network parameters to devices on a network. For example, the network address server 110 (e.g., a Dynamic Host Configuration Protocol (DHCP) server) can employ a protocol to automatically assign a network address (e.g., an Internet Protocol (IP) address) to any of the devices 102a-x when the devices attempt to connect to the network(s) 150. Techniques for assigning an IP address, for example, can include dynamic allocation, automatic allocation, and/or manual allocation.

The device service platform 120, for example, can represent a platform that is implemented across multiple servers, including but not limited to network servers, web servers, application servers, or other suitable computing servers. In general, the device service platform 120 can be configured to perform various operations for automatically monitoring Internet of Things (IoT) devices (e.g., at least some of the devices 102a-x), and for automatically recovering such devices in the event of disconnection and/or failure. Each of the various operations, for example, can be implemented as a computer service (e.g., through software components such as applications, modules, objects, or other suitable software components), which may be combined or separate, and may be co-located (e.g., executed by a same server) or distributed (e.g., executed by different servers). In the present example, the device service platform 120 includes a heartbeat service 122, a recovery service 124, a configuration service 126, and an event analysis service 128. In general, the heartbeat service 122 can be configured to automatically monitor the devices 102a-x to verify that the devices are connected to the network(s) 150, 152, the recovery service 124 can be configured to automatically attempt recovery of disconnected/non-operational devices 102a-x, the configuration service 126 can be configured to automatically configure at least some of the devices 102a-x, and the event analysis service 128 can be configured to automatically detect event patterns that are associated with disconnected/non-operational devices 102a-x.

Each of the various data stores (e.g., event data store 130, location data store 140, and configuration data store 142) can represent one or more databases, file systems, and/or cached data sources. In general, the device service platform 120 can be configured to perform various data operations (e.g., selecting, updating, deleting, inserting, etc.) on the data maintained by the data stores 130, 140, and 142. The event data store 130, for example, can be configured to maintain event data (e.g., events related to device discoveries, device name changes, firmware changes, configuration changes, password resets, device resets, device reboots, device recoveries, unresponsive incidents, unauthorized incidents, or other sorts of device events) that pertain to the devices 102a-x. The location data store 140, for example, can be configured to maintain data that corresponds to locations of at least some of the devices 102a-x. The configuration data store 142, for example, can be configured to maintain data that is used to configure at least some of the devices 102a-x.

The networks 150 and 152, for example, can represent computer communication networks that are maintained by and/or used by an entity (e.g., an individual, an organization, etc.) that operates the system 100. In general, the network 150 can represent a wide area network (WAN) and/or the Internet, whereas the network 152 can represent a local area network (LAN). In the present example, the network 150 includes server(s) for running one or more centralized services of the device service platform 120 (e.g., the recovery service 124, the configuration service 126, and the event analysis service 128), the various data stores 130, 140, and 142, and the network address server 110. The network 152 in the present example includes the various IoT devices (e.g., devices 102a-x) and network devices (e.g., the switch/router 104) for handling network communication to and from the IoT devices, and can optionally include server(s) for running one or more localized services of the device service platform 120 (e.g., the heartbeat service 122). For example, the network 152 can be a LAN that provides network services for a facility that includes the devices 102a-x. In some examples, the system 100 can include multiple LANs, with each LAN providing local network services for a respective facility that includes a respective set of IoT devices. The multiple LANs, for example, can each be configured to communicate with the network(s) 150 (e.g., a WAN and/or the Internet) of the system 100, in order to provide device access to the network address server 110 and centralized services of the device service platform 120.

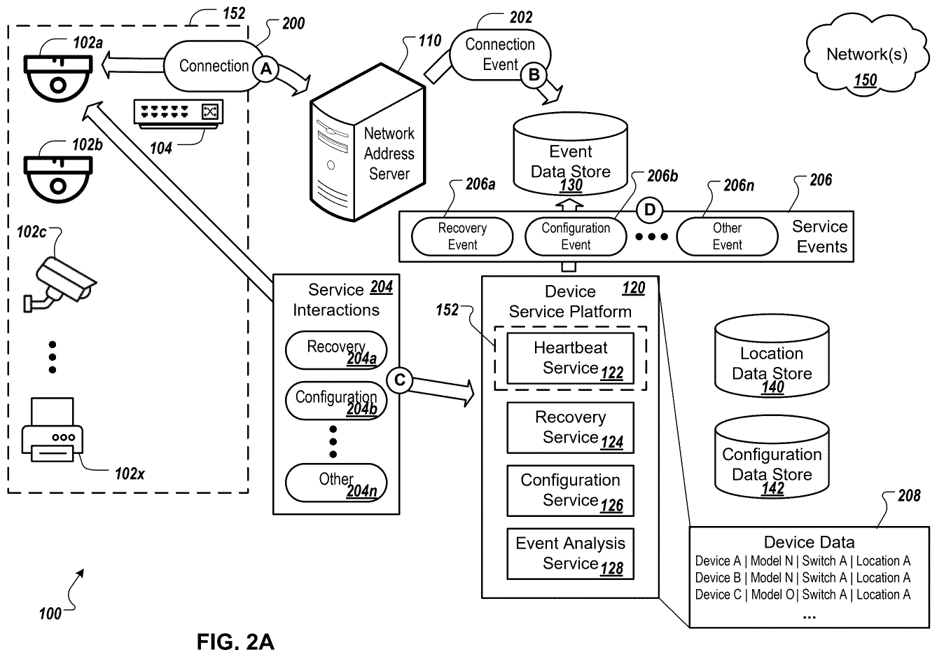

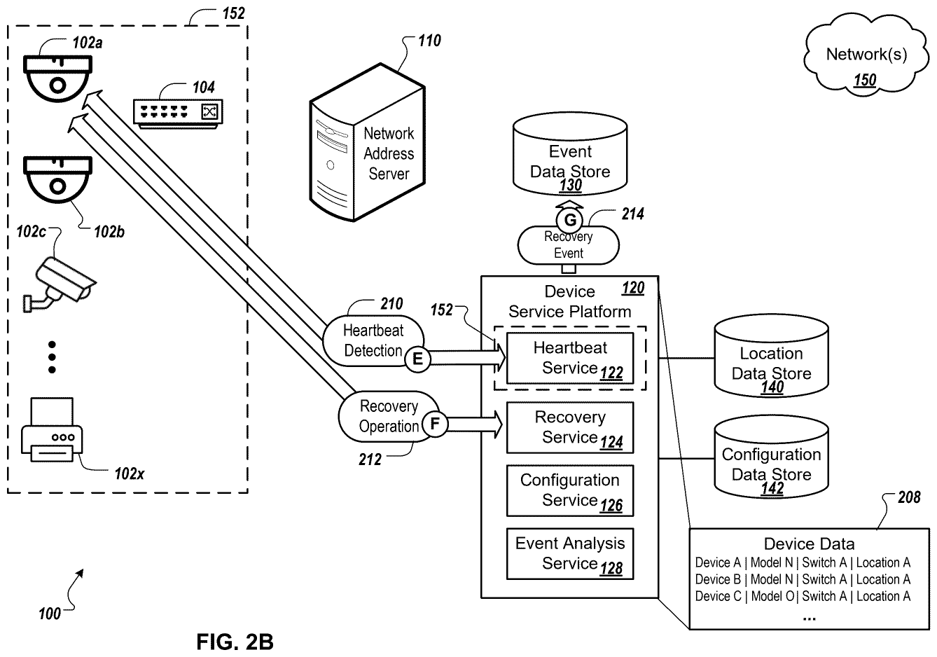

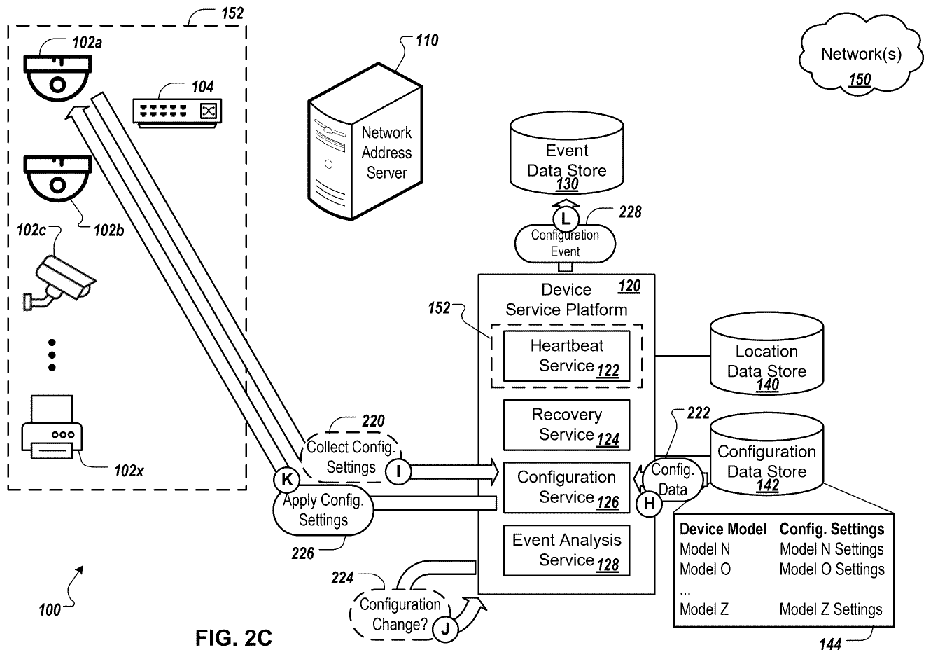

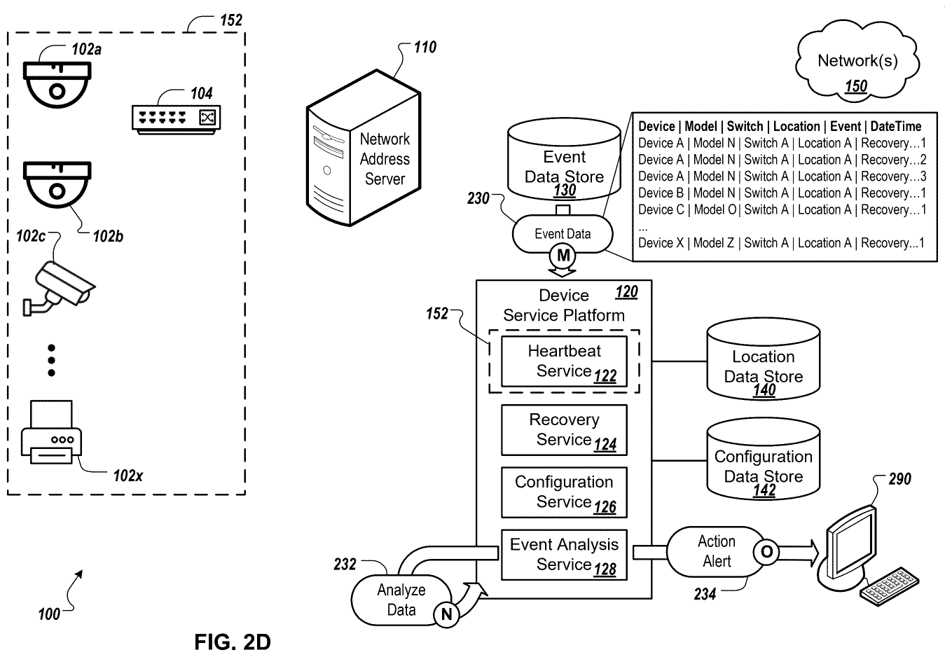

Referring now to FIGS. 2A-2D, an example illustrative process is shown for performing automated monitoring and recovery of Internet of Things (IoT) devices (e.g., cameras and/or other types of devices) across a computer network, as represented in example stages (A) to (O). Stages (A) to (O) may occur in the illustrated sequence, or they may occur in a sequence that is different than in the illustrated sequence and/or two or more stages (A) to (O) may be concurrent. In some examples, one or more stages (A) to (O) may be repeated multiple times when servicing the IoT devices. Further, and with respect to stages (A) to (O), an example data flow through the system 100 is illustrated, with arrows representing a general direction of the flow of data. However, it is to be understood that any of the stages (A) to (O) can potentially include bi-directional communication between system components, with either of the components potentially initiating a transfer of data between the components (e.g., using push, pull, application programming interface (API) calls, data subscription, etc.).

Referring to FIG. 2A, operations are shown for generating and maintaining event data associated with IoT devices that are in communication with an entity's network. In general, an event includes data that represents a state change across the system 100 (e.g., an occurrence of a state change to any of the devices 102a-x), can be generated by services of the device service platform 120 and/or the network address server 110, and can be maintained by the event data store 130. For example, event data can be related to device discoveries, device name changes, firmware changes, configuration changes, password resets, device resets, device reboots, device recoveries, unresponsive incidents, unauthorized incidents, or other sorts of events that pertain to the devices 102a-x.

During stage (A), a connection between an IoT device and one or more networks can occur. For example, when the device 102a (e.g., a security camera in a facility serviced by the LAN 152 and the WAN/Internet 150) attempts to establish a connection 200 to the networks 150, 152 (e.g., when powering up, when rebooting, or when performing another sort of operation for which a network connection is to be established or re-established), the device 102a can transmit an address request to the network address server 110 via the switch/router 104. In the present example, the switch/router 104 receives the address request, and forwards the address request to the network address server 110 (which can be in a centralized location that services multiple different facilities, with each facility also being serviced by a different local area network 152). In general, an address request includes data that identifies a requesting device, such as a media access control (MAC) address that uniquely identifies the device 102a (with a portion of the MAC address identifying a manufacturer/model of the device). In response to receiving the address request over the networks 150, 152, for example, the network address server 110 can provide a unique network address (e.g., an Internet Protocol (IP) address) for the device 102a (and optionally, other identifying information such as a host name). In the present example, the switch/router 104 receives the network address from the network address server 110, and forwards the address to the device 102a. After receiving the network address, for example, the device 102a can proceed to use the network address when sending and receiving data over the networks 150, 152.

During stage (B), a connection event can be transmitted to an event data store. In general, an event includes data that represents a state change across the system 100 (e.g., an occurrence of a state change to any of the devices 102a-x), with connection events being triggered in response to network connections occurring. The event data store 130, for example, can be configured to receive and store connection events that occur when any of the devices 102a-x connect to the networks 150, 152, among other sorts of events. In some implementations, an event data store can be an event streaming platform. For example, the event data store 130 can subscribe to and publish streams of events, can store such events in an ordered log, and can process such events as they occur. In the present example, the network address server 110 transmits connection event 202 (e.g., an event including data that pertains to the newly established network connection of the device 102a, such as the device's MAC address, the device's assigned IP address, the device's assigned host name, etc.), and the event data store 130 maintains the connection event 202 for further reference and processing. For example, the device service platform 120 can receive connection event data (e.g., including the device's MAC address, the device's assigned IP address, the device's assigned host name, etc.) that pertains to the connection event 202. To receive the connection event data, for example, the device service platform 120 can subscribe to a topic (e.g., a data feed name) that includes connection events that occur across the system 100. As another example, another sort of data transmission technique (e.g., data polling, data pushing, etc.) can be used to provide the connection event data to the device service platform 120.

In some implementations, device location data can be determined for a device that is to be serviced by a device service platform. For example, the device service platform 120 can use one or more device addresses of the device 102a (e.g., the device's MAC address and/or the device's assigned IP address) to query the location data store 140 (e.g., a data store that is associated with the network address server 110) to identify a physical location (e.g., a facility) at which the device 102a is located. In the present example, the device service platform 120 can receive location data from the location data store 140 indicating that the device 102a is located at a facility in which the LAN 152 operates.

After discovering that a connection between an IoT device and one or more networks has occurred, device data that pertains to the device that is to be serviced can be maintained (e.g., in memory, in persistent data storage, etc.). For example, the device service platform 120 can maintain device data 208 that pertains to each device that has connected to the networks 150, 152 (e.g., including the device's MAC address, the device's assigned IP address, the device's assigned host name, the device's model, the device's current switch, the device's physical location, etc.). In the present example, the device data 208 includes the most recently available data for the device 102a (e.g., a device that has been newly added to the networks 150, 152, or an existing device that has performed a power cycle and/or has refreshed its network address), and can be used for facilitating further interactions between the device 102a and the device service platform 120.

During stage (C), various interactions can occur between IoT devices and services of a device service platform. For example, service interactions 204 between the device 102a and the device service platform 120 can include recovery interactions (e.g., recovery interaction 204a), configuration interactions (e.g., configuration interaction 204b), and other service interactions (e.g., other interactions 204n). The recovery interaction 204a, for example, can involve one or more interactions in which the device 102a is detected as being disconnected from the networks 150, 152, and a recovery operation for the device 102a is automatically performed by the device service platform 120. Recovery operations are further described with respect to FIG. 2B. The configuration interaction 204b, for example, can involve one or more interactions in which a configuration operation (e.g., including an application of updated configuration settings, default configuration settings, preferred configuration settings, etc.) for the device 102a is automatically performed by the device service platform 120. Configuration operations are further described with respect to FIG. 2C. Other service interactions 204n (e.g., involving device cleanup operations, device firmware updates, device reboots, device rests, etc.) are possible.

During stage (D), various service events can be transmitted to an event data store. For example, the event data store 130 can receive and store service events 206 that occur when any of the devices 102a-x interact with services of the device service platform 120. The recovery service 124 of the device service platform 120, for example, can transmit a recovery event 206a (e.g., an event including data that pertains to an automated recovery of the device 102a) to the event data store 130. As another example, the configuration service 126 of the device service platform 120 can transmit a configuration event 206b (e.g., an event including data that pertains to an automated configuration or reconfiguration of the device 102a) to the event data store 130. As another example, another service of the device service platform 120 can transmit another sort of event (e.g., other event 206n) to the event data store 130. Upon receiving any of the service events 206, for example, the event data store 130 can maintain the event for further processing and analysis. Event analysis operations are further described with respect to FIG. 2D.

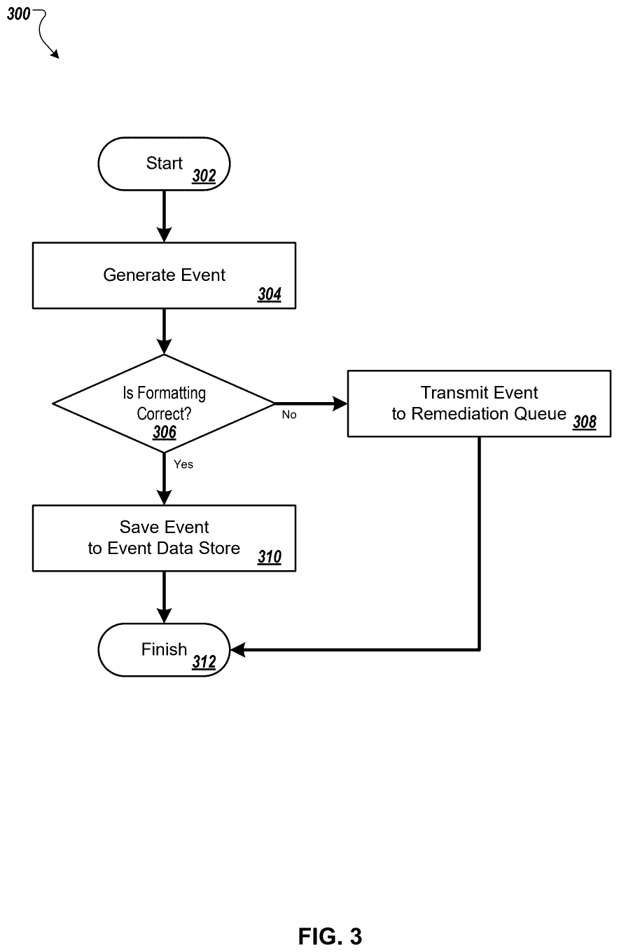

Referring now to FIG. 3, a flow diagram is shown of an example technique 300 for processing and maintaining events related to Internet of Things (IoT) devices. Operations of the technique 300, for example, can be performed for a service event (e.g., any of the service events 206), in response to the event having been generated by a service of the device service platform 120 (e.g., any of the services 122, 124, 126, 128, or another platform service). For example, the device service platform 120 can include an event handler that receives, processes, and transmits generated events. In the present example, the technique 300 can be performed by components of the system 100 (shown in FIG. 1) according to the event generation and transmission stages (A) through (D) (shown in FIG. 2A), and will be described as such for clarity. However, the technique 300 can also be performed by other platforms and systems.

At 302, the example technique 300 starts, and at 304 an event is generated. In the present example, a service of the device service platform 120 (e.g., any of the services 122, 124, 126, 128, or another platform service) can generate a service event 206 that corresponds to one or more operations being performed for the device 102a. In general, a generated service event can have a consistent event schema that facilitates event processing and analysis across downstream processes. For example, each of the service events 206 can be formatted to include multiple event fields, with each event field having a corresponding field value. In the present example, event fields of the event service events 206 can include an event name (e.g., a name of the event that indicates a particular type of service operation having been performed), an event source (e.g., an identifier of a service/server that generated the event), a job identifier that identifies an asynchronous job associated with handling the event, a flag that indicates whether an event operation was successful or unsuccessful, a stage name (e.g., a name of a last event stage executed, used to track event progress), an device address (e.g., a MAC address of the device), a device hostname, a device model, a device location, a trace identifier (e.g., used for distributed event tracing), a span identifier (e.g., used for distributed event tracing), a duration (e.g., an amount of time for performance of the event from a start time to a time of event generation), a timestamp (e.g., a date/time at which the event was generated, and/or event details (e.g., event data maintained in an array of key/value pairs). In some examples, additional event data can be maintained for each of the service events 206 when the events are added to the event data store 130, such as an event identifier (e.g., an identifier of a record in the event data store 130).

At 306, a determination is performed of whether event formatting is correct. For example, the event handler of the device service platform 120 can determine whether the service event 206 is formatted according to the consistent event schema, and whether the field values of the event fields have appropriate values. If the event formatting is incorrect, at 308 the event can be transmitted to a remediation queue. For example, the device service platform 120 can maintain the remediation queue, and an operator of the platform can periodically review the queue to identify and correct events that have been formatted incorrectly and/or events that include incorrect field values.

At 310, if the event formatting is correct, the event can be saved to an event data store. For example, the device service platform 120 can save the service event 206 to the event data store 130, among other service events and connection events. Operations for saving an event are also described with respect to stage (D), (shown in FIG. 2A). After saving the event to the event data store 130 or transmitting the event to the remediation queue, for example, the technique can finish at 312.

Referring to FIG. 2B, operations are shown for automatically monitoring Internet of Things (IoT) devices (e.g., cameras and/or other types of devices), and for automatically recovering disconnected/non-operational devices. Through the automated monitoring and recovering operations, for example, the system 100 can automatically identify devices that are expected to be connected to the networks 150, 152, and can determine whether the devices are actually connected to the network and are operating correctly. If a device is not connected and is not operating correctly, for example, the system 100 can automatically perform a recovery operation in an attempt to return the device to a connected and operational state. The automated monitoring and recovering operations can be performed at appropriate times and without employing manually-driven processes, for example.

During stage (E), a heartbeat detection process can be performed for an IoT device. In general, heartbeat detection is a periodic process for monitoring a device, that indicates whether the device is reachable over a network and whether the device is operating normally. For example, the device service platform 120 can employ the heartbeat service 122 (e.g., a localized service of the platform that operates over the LAN 152) to perform a heartbeat detection process 210 for the device 102a. By executing the heartbeat detection process 210 through a localized service, for example, network traffic can be reduced for an enterprise that manages a large number of devices across a WAN/Internet, while providing current device data for devices of a facility to downstream processes (e.g., recovery/configuration operations).

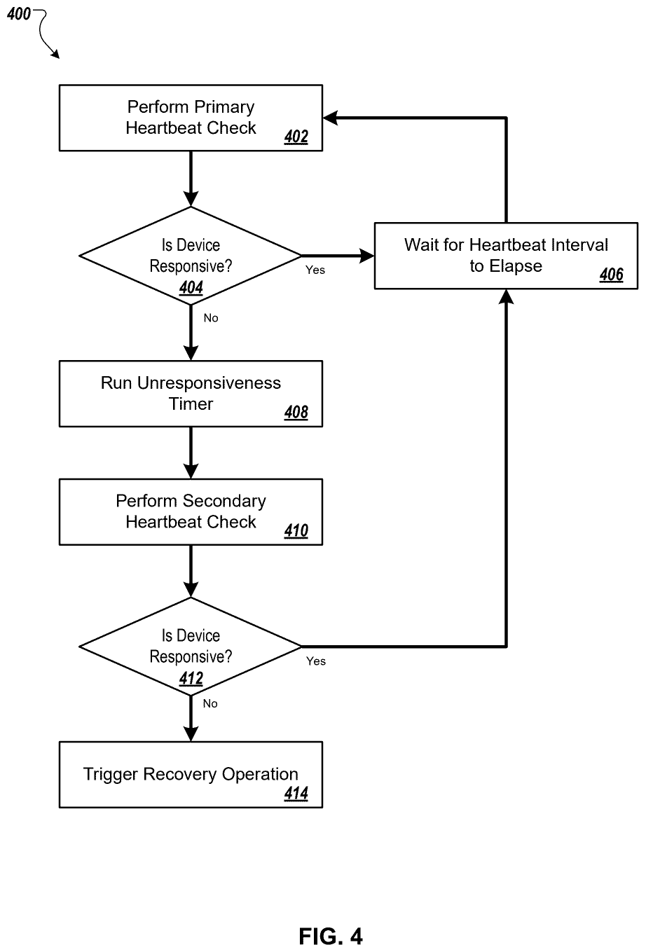

Referring now to FIG. 4, a flow diagram is shown of an example technique 400 for monitoring and for triggering recovery operations for Internet of Things (IoT) devices. Operations of the technique 400, for example, can be periodically performed for an IoT device, when the device is expected to be communicating and operating on the networks 150, 152 (e.g., according to the device data 208 maintained by the device service platform 120). In the present example, the technique 400 can be performed by components of the system 100 (shown in FIG. 1) according to the heartbeat detection stage (E) (shown in FIG. 2B), and will be described as such for clarity. However, the technique 400 can also be performed by other platforms and systems.

At 402, a primary heartbeat check is performed for a device. For example, the device service platform 120 can reference the device data 208 to identify a device that is expected to be connected to the networks 150, 152, and can in turn perform the primary heartbeat check for the identified device. In the present example, the device 102a (e.g., “Device A”) is identified as having previously connected to the LAN 152 and having been registered as a device of the LAN 152. The device service platform 120, for example, can use the heartbeat service 122 to perform the primary heartbeat check for the device 102a, to determine whether the device is responsive (at 404), and if so, to wait for the heartbeat interval to elapse (at 406) before performing another primary heartbeat check (at 402).

In some implementations, a primary heartbeat check can be a network ping that is initiated by a monitoring service to test the reachability of a device over a network. For example, the heartbeat service 122 of the device service platform 120 can use the device data 208 to identify a device address of the device 102a (e.g., the IP address), and can ping the device to test its reachability over the LAN 152. In general, various protocols can be used to ping a device, such as Internet Control Message Protocol (ICMP), Transmission Control Protocol (TCP), Hypertext Transfer Protocol (HTTP), Simple Network Management Protocol (SNMP), or other suitable network communication protocols. The ICMP protocol, for example, can run at Layer 3 (network) of the Open Systems Intercommunication (OSI) model, can have a fixed timeout, and can be used to perform a de facto check of whether a device is on a network. The TCP protocol, for example, can run at Layer 4 (transport) of the OSI model, is generally slower than the ICMP protocol, can have a configurable timeout, and can be used to perform an authoritative determination of whether a device is listening on a queried port. The HTTP protocol, for example, can run at Layer 8 (application) of the OSI model, is generally slower than the TCP protocol, and can be used to perform an authoritative determination of whether a device is responding over a queried port (e.g., by connecting to the device port and communicating with a service running on that port). The SNMP protocol, for example, can be used when a Transport Layer Security (TLS) certificate exists on a device, and can be used to retrieve additional information about a device (e.g., operational information). In the present example, the heartbeat service 122 can be configured to initiate device pings, however in other implementations, at least some of the devices 102a-x can be configured to periodically initiate the device pings.

In some implementations, a primary heartbeat check can occur at a predetermined regular time interval. For example, the heartbeat service 122 can perform the primary heartbeat check (at 402) once per minute, once every five minutes, one every ten minutes, or at another suitable time interval. In some implementations, a predetermined regular time interval for performing a primary heartbeat check can a same time interval for all devices in across a network. In some implementations, a predetermined regular time interval for performing a primary heartbeat check can be a model-specific time interval, with different device models being associated with different time intervals. For example, a first model (e.g., “Model A”) can be associated with a configuration setting that specifies that devices of that model are to be periodically checked at a first time interval (e.g., one minute), and a second model (e.g., “Model B”) can be associated with a configuration setting that specifies that devices of that model are to be periodically checked at a second time interval (e.g., two minutes).

At 408, if the device is not responsive, an unresponsiveness timer can be run. For example, in response to not receiving acknowledgement data from the device 102a that corresponds to the primary heartbeat check, the heartbeat service 122 can start the unresponsiveness timer for the device 102a and can pause the regular performance of primary heartbeat checks while the unresponsiveness timer runs. The unresponsiveness timer, for example, can run for a configurable amount of time (e.g., five minutes, ten minutes, or another amount of time that is generally greater than an amount of time for the heartbeat interval) that can optionally be specific for a particular device model. In general, by waiting for the unresponsiveness timer to elapse, scenarios can be accounted for in which a device is temporarily disconnected from the network (or is not communicating over the network), but is otherwise operational. For example, when the primary heartbeat check is being performed, the device 102a may be in the process of a manually initiated reboot, of which the device service platform 120 has not received a notification. As another example, when the primary heartbeat check is being performed, the device 102a may be manually disconnected from the LAN 152 (e.g., for the purpose of connecting the device to a different switch/router 104). Other temporary disconnection scenarios are possible.

At 410, a secondary heartbeat check can be performed in response to the unresponsiveness timer having elapsed. For example, the heartbeat service 122 can track the running of the unresponsiveness timer for the device 102a, and when the unresponsiveness timer has elapsed, can perform the secondary heartbeat check. Similar to the primary heartbeat check, for example, the heartbeat service 122 of the device service platform 120 can use the device data 208 to identify a device address (e.g., the IP address) of a device that is associated with an elapsed unresponsiveness timer, and can ping the device to test its reachability over the LAN 152. In some implementations, a protocol used to monitor (e.g., ping) a device during a secondary heartbeat check can be a same protocol that was used to monitor the device during a primary heartbeat check. In some implementations, a protocol used to monitor (e.g., ping) a device during a secondary heartbeat check can be a different protocol than a protocol that was used to monitor the device during a primary heartbeat check. For example, the protocol used to monitor the device 102a during the periodically performed primary heartbeat check can be a relatively lightweight protocol (e.g., ICMP, TCP, etc.) that quickly performs a device responsiveness check while transferring a small amount of data over the LAN 152. The protocol used to monitor the device 102a during the conditionally performed secondary heartbeat check, for example, can be a relatively heavyweight protocol (e.g., HTTP, SNMP, etc.) that may take more time to perform a device responsiveness check while involving the transfer of more data over the LAN 152, with the benefit of potentially providing additional data about the device 102a. The additional data, for example, can be used for performing device diagnostics (e.g., determining whether the device 102a is operating normal), and/or as input for downstream processes (e.g., recovery operations).

At 412, another determination can be performed of whether the device is responsive. For example, the heartbeat service 122 of the device service platform 120 can determine whether the device 102a is responsive, based on data obtained from the secondary heartbeat check. If the device 102a is responsive (e.g., the device had been temporarily offline during a regular primary heartbeat check, but is found to now be online during the secondary heartbeat check), the technique 400 can continue, by again waiting for regular heartbeat intervals to elapse (at 406), and performing primary heartbeat checks (at 402). If the device 102a is unresponsive (e.g., the device is found to still be offline during the secondary heartbeat check), the technique 400 can continue at 414, by triggering an operation to attempt to recover the device 102a.

Referring again to FIG. 2B, during stage (F), a recovery operation can be performed for the IoT device. In general, recovery operations can involve power cycling, resetting, and/or reconfiguring a device, in an attempt to restore the device to an operational state. For example, in response to detecting that the device 102a is offline and/or unresponsive after a secondary heartbeat check, the heartbeat service 122 can trigger an alert that is detected by the recovery service 124 of the device service platform 120 (e.g., a centralized service that handles the recovery of devices across various different locations operating different LANs 152), and in response to detecting the alert, the recovery service 124 can perform a recovery operation 212 for the device 102a (e.g., through an application programming interface (API) of the device model). By executing the recovery operation 212 through a centralized service, for example, the operation logic can be centrally implemented and maintained across an enterprise.

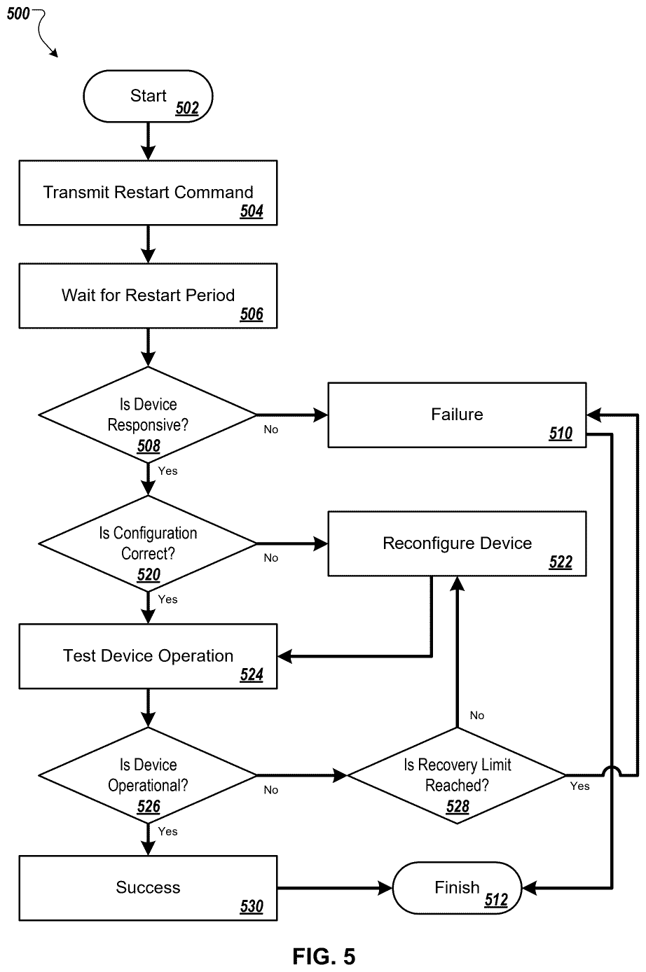

Referring now to FIG. 5, a flow diagram is shown of an example technique 500 for performing recovery operations for Internet of Things (IoT) devices. Operations of the technique 500, for example, can be performed for an IoT device when the device has been determined as being unresponsive and/or non-operational on the networks 150, 152 (e.g., according to the heartbeat detection process 210 performed during stage (E)). In the present example, the technique 500 can be performed by components of the system 100 (shown in FIG. 1) according to the recovery operation stage (F), (shown in FIG. 2B), and will be described as such for clarity. However, the technique 500 can also be performed by other platforms and systems.

At 502, the example technique 500 starts, and at 504, a restart command is transmitted. In some implementations, a restart command can be transmitted to a device. For example, the recovery service 124 of the device service platform 120 can reference the device data 208 to identify a device address of the device 102a (e.g., the IP address), and can transmit a command to the device 102a to restart (e.g., through an application programming interface (API) of the device). In some implementations, a restart command can be transmitted to a switch. For example, the recovery service 124 of the device service platform 120 can reference the device data 208 to identify the switch/router 104 that provides power/communication services for the device 102a, and can then transmit a command to the switch/router 104 to perform a port bounce of the device 102a (e.g., through an application programming interface (API) of the switch). In the present example, the port bounce can include turning off the port to which the device 102a is connected (thereby turning off the power to the device), waiting an appropriate amount of time (e.g., depending on the device model), and turning the port back on.

At 506, the example technique involves waiting for a restart period to complete. For example, after transmitting a restart command to the device 102a or the switch/router 104, the recovery service 124 can execute a restart timer that waits an appropriate amount of time for the device 102a to restart (e.g., 3 minutes, 5 minutes, 10 minutes, or another appropriate amount of time that can optionally vary based on the model of the device). In the present example, when the restart timer has elapsed, the recovery service 124 can determine whether the device is responsive at 508. Determining device responsiveness, for example, can include techniques similar to those described with respect to performing a primary or secondary heartbeat check (see FIG. 4). As another example, rather than waiting for the restart timer to elapse before determining whether the device 102a is responsive, the recovery service 124 can periodically (e.g., twice per minute, once per minute, etc.) ping the device 102a (e.g., similar to the primary or secondary heartbeat check) to determine whether the device is responsive, until such time that the restart period has completed. If the device 102a is found to be responsive before the restart period has completed, for example, the recovery service 124 can stop pinging the device 102a and the technique 500 can continue at 520. If the device 102a remains unresponsive when the restart period has completed, for example, a recovery failure event can be generated by the recovery service 124 at 510, and the technique 500 can finish at 512.

At 520, if the device is responsive, a determination can be performed of whether the device configuration is correct. For example, the recovery service 124 can transmit a command to the configuration service 126 to perform a configuration check on the device 102a to ensure that the device 102a is configured properly. In general, performing the configuration check can involve collecting current configuration settings for a device, and comparing the current configuration settings to preferred/default configuration settings for the device (or device model) to determine whether a configuration change has occurred. Operations for performing the configuration check are described in further detail with respect to stages (H), (I), and (J) of FIG. 2C.

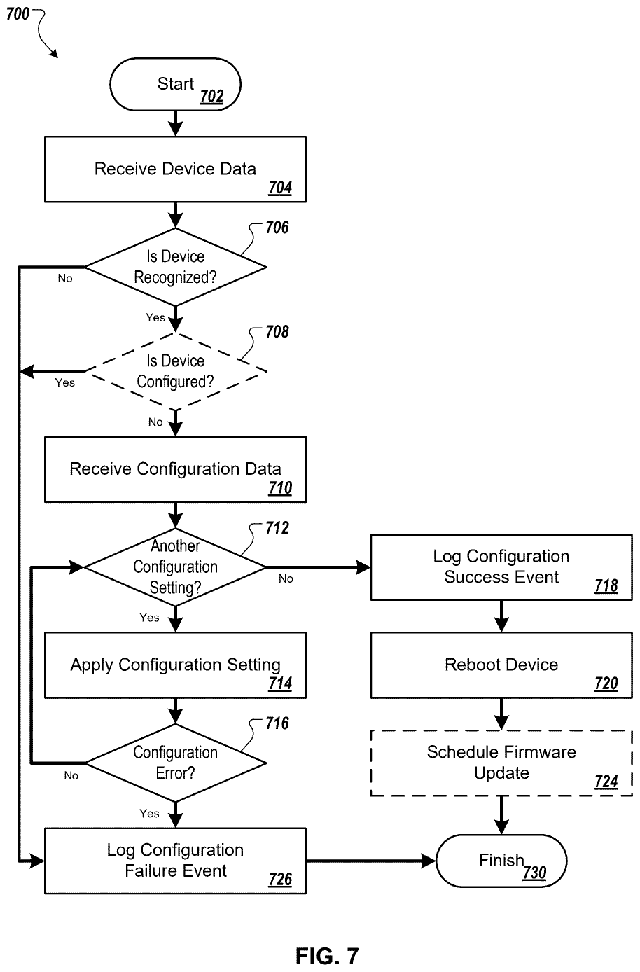

At 522, if the configuration is incorrect, the device can be reconfigured. For example, the configuration service 126 of the device service platform 120 can reconfigure the device 102a to restore the device to its preferred/default configuration settings. In general, reconfiguring a device includes establishing a remote connection to the device and executing a configuration settings application script that applies the preferred/default configuration settings to the device. Operations for applying configuration settings to a device are described in further detail with respect to stage (K) of FIG. 2C, and the example technique 700 of FIG. 7.

At 524, if the configuration is correct (or after reconfiguring the device), device operation can be tested, and at 526, a determination can be performed of whether the device is operational. In general, testing the operation of a device can include performing a check to determine whether the device is performing its main functions. For example, testing the device operation can include interfacing with a device application programming interface (API), issuing a command to perform a device function (or a request for device data), and receiving an indication of whether the command was successfully performed (or the device data request was successfully fulfilled). For video camera devices, for example, testing the operation can include interfacing with an API to determine whether the device is capable of streaming video. In the present example, if the device 102a is operational, a recovery success event can be generated by the recovery service 124 at 530, and the technique 500 can finish at 512.

At 528, if the device is not operational, a determination can be performed of whether a recovery limit has been reached. For example, the recovery service 124 can reference the event data store 130 to identify instances of past recovery operations that have been performed for the device 102a (e.g., including successful and failed recoveries), based on previously generated recovery success events and recovery failure events. If a number of past recovery operations meets a predetermined threshold number for a given time period (e.g., three recoveries per hour, six recoveries per week, ten recoveries per month, or another suitable threshold number of recoveries), for example, the recovery limit is reached. In the present example, a recovery failure event can be generated by the recovery service 124 at 510, and the technique can finish at 512. If the number of past recovery operations does not meet the predetermined threshold number for the given time period, for example, the recovery limit is not yet reached, and the recovery service 124 can again attempt to reconfigure the device 102a at 522. Optionally, a factory reset can be performed on the device 102a before attempting another reconfiguration. By checking a recovery limit, for example, potential infinite process loops can be prevented in the recovery operation. Further, an excessive number of recovery operations for a particular device, switch, or location can indicate a broader problem that can benefit from additional investigation (and possible replacement of the device and/or switch).

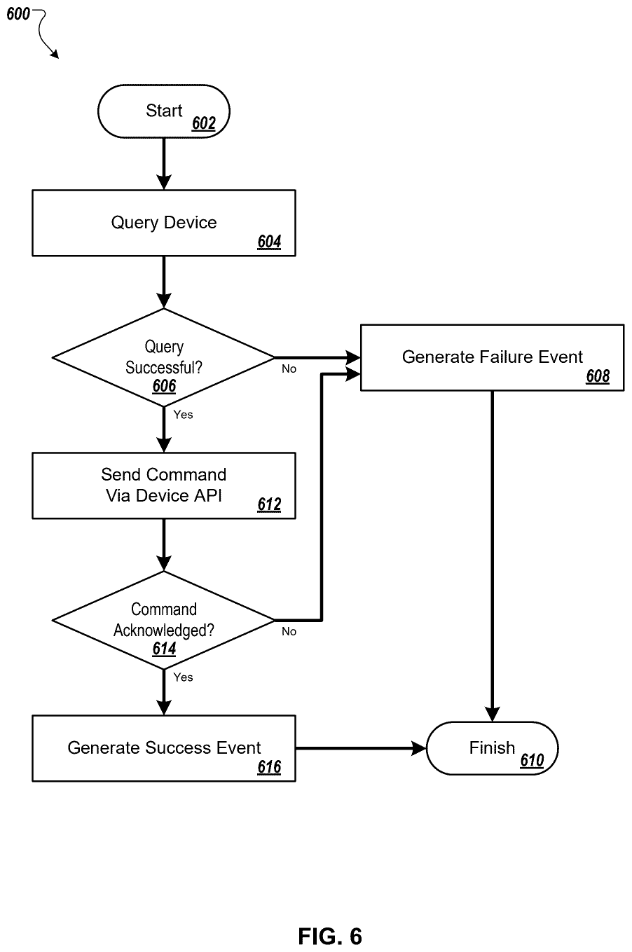

Referring now to FIG. 6, a flow diagram is shown of an example technique 600 for transmitting commands to Internet of Things (IoT) devices, and for generating associated events. Operations of the technique 600, for example, can be performed for an IoT device when sending a command to the device through an application programming interface (API), such as a reboot command, a factory reset command, a configuration application command, an operational test command, or another sort of command that involves an action to be performed by the device in response to the command, and a potential success or failure in performing the action. Such commands are also described with respect to the example technique 500 (shown in FIG. 5) and the example technique 700 (shown in FIG. 7).

At 602, the example technique 600 starts, and at 604, the device (e.g., device 102a) is queried (e.g., including a request for current device data). At 606, for example, a determination can be performed of whether the query is successful. If the query is not successful, for example, a failure event can be generated at 608, and the technique 600 can finish at 610. If the query is successful, for example, a command can be sent to the device 102a via a device API at 612. At 614, a determination can be performed of whether the command is acknowledged. In the present example, if the device 102a does not acknowledge the command, a failure event can be generated at 608, and the technique can finish at 610. However, if the device 102a does acknowledge the command, a success event can be generated at 616, and the technique can finish at 610.

Referring again to FIG. 2B, during stage (G), one or more events can be maintained that pertain to the performed recovery operation. For example, recovery event 214 (e.g., a recovery success event or a recovery failure event) can be transmitted to the event data store 130 by the device service platform 120, after attempting to perform the recovery operation 212. The recovery event 214, for example, can optionally include data related to the device, model, switch, location, date/timestamp, success/failure, and other relevant event data. Optionally, additional events related to the recovery operation 212 (e.g., reboot events, reset events, configuration events, etc.) can also be maintained, with relevant event data and success/failure information. As will be described with respect to FIG. 2D, the event data can be aggregated and analyzed to identify broad actions to be performed with respect to the devices 102a-x of the system 100 (e.g., including the identification of faulty hardware and the formulation of hardware replacement strategies).

Referring to FIG. 2C, operations are shown for automatically configuring (or reconfiguring) Internet of Things (IoT) devices (e.g., cameras and/or other types of devices. Through the automated configuration operation, for example, the system 100 can automatically configure devices at appropriate times and without employing manually-driven processes. Further, the automated configuration operation can be executed to rectify configuration drift (e.g., applied configuration changes to a device that deviate from a configuration that is preferred by an operator and/or organization), thereby improving a device's security posture, and improving the ability to integrate the device into various enterprise operations.

During stage (H), configuration data can be received for an IoT device. For example, the device service platform 120 can employ the configuration service 126 (e.g., a centralized service of the platform that operates over the WAN/Internet 150) to receive configuration data 222 for the device 102a. The configuration service 126 can use a unique identifier of the device 102a (e.g., the device's MAC address) and/or a model identifier of the device's model to query the configuration data store 142 (e.g., a data store that has been populated with configuration settings 144 for various devices and/or device models) to identify a set of preferred configuration settings for the device 102a.

In some implementations, a model identifier of a device model can be included in a unique device identifier. For example, the configuration service 126 can parse the unique identifier of the device 102a (e.g., the device's MAC address) to identify the device 102a as being a particular device model. In the present example, through a suitable model identification technique (e.g., by parsing the unique identifier of the device 102a, by accessing a lookup table that maps device identifiers to model identifiers, etc.), the configuration service 126 can determine the device model of the device 102a (e.g., “Model N”), can query the configuration data store 142 to identify preferred configuration settings for the device model (e.g., “Model N Settings”), and can receive the preferred settings in the configuration data 222. As another example, preferred configuration settings can be maintained in the configuration data store 142 (and can be queried) for particular devices.

In some implementations, preferred configuration settings can vary based on a device location. For a particular device model, for example, a first set of preferred configuration settings can exist for devices of a particular model at a first location, and a second, different set of preferred configuration settings can exist for devices of the particular model at a second, different location. Thus, different facilities/LANs can specify different preferred configuration settings for a same model of device.

During stage (I), currently used configuration settings can optionally be collected for an IoT device. For example, the device service platform 120 can employ the configuration service 126 to communicate with the device 102a over the WAN/Internet 150 and the LAN 152, and to automatically collect configuration settings 220 that are currently being used by the device 102a. In the present example, the configuration service 126 can establish a remote connection to the device 102a over the networks 150, 152, can identify the device 102a as being of a particular device model (e.g., “Model N”), and can collect the current configuration settings 220 of the device 102a using a configuration collection script for the particular device model (e.g., “Model N”).

During stage (J), a determination can optionally be performed of whether the IoT device's current settings match the preferred configuration settings for the device. For example, the device service platform 120 can employ the configuration service 126 to perform a configuration change determination process 224, in which the current configuration settings 220 of the device 102a are compared to the set of preferred configuration settings (e.g., included in the received preferred configuration data 222) for the device 102a. In general, when a device's current configuration settings are determined as matching the device's preferred configuration settings, a configuration settings change has not occurred, and the configuration operation (or reconfiguration operation) can terminate. However, when a device's current configuration settings are determined as being different from the device's preferred configuration settings, a configuration settings change has occurred, and the device's preferred configuration settings can be applied to the device. In the present example, the current configuration settings 220 of the device 102a do not match its preferred configuration settings in the configuration data 222, indicating that a configuration settings change (e.g., due to a manual change recently applied by a device operator), and the preferred configuration settings can be reapplied to the device 102a.

During stage (K), configuration settings can be applied to the IoT device. For example, the device service platform 120 can employ the configuration service 126 to perform a configuration operation 226, in which the service 126 communicates with the device 102a over the WAN/Internet 150 and the LAN 152, and automatically applies the preferred configuration settings for the device 102a included in the configuration data 222. Applying preferred configuration settings can generally include establishing a remote connection to a device, and executing a configuration settings application script that applies each of the settings to the device. In the present example, the configuration service 126 can establish a remote connection to the device 102a over the networks 150, 152, and can apply the preferred “Model N Settings” to the device 102a using a configuration settings application script that has been designed to apply configuration settings for “Model N” devices (e.g., using a communication protocol that specific to that model). The preferred configuration settings, for example, can include various security settings, network configuration settings, system settings, media configuration settings, analytics settings, event handling settings, and/or other settings that are particular to a device and/or device model.

Referring now to FIG. 7, a flow diagram is shown of an example technique 700 for performing automated configuration of Internet of Things (IoT) devices. In the present example, the technique 700 can be performed by components of the system 100 (shown in FIG. 1) according to the automated configuration stages (H) through (K) (shown in FIG. 2C), and will be described as such for clarity. However, the technique 400 can also be performed by other platforms and systems.

At 702, the example technique 700 starts, and at 704, device data is received for an IoT device of the system 100. In the present example, the configuration service 126 of the device service platform 120 receives device data (e.g., a MAC address, an IP address, a host name, a physical location) that pertains to the device 102a. The device data, for example, can include data collected during the connection operation 200 (shown in FIG. 2A), and can be retrieved by the device service platform 120 (e.g., from a data store of device data that pertains to devices that are or have been connected to the networks 150, 152) when configuring devices.

At 706, a determination is performed of whether the device is recognized. For example, the configuration service 126 of the device service platform 120 can determine whether the device 102a is recognized, by determining whether the device data of the device 102a is valid, and whether the device 102a is currently online. If the device is not recognized (e.g., the device data is not valid and/or the device 102a is not currently online), the configuration service 126 can log a configuration failure event (at 726), and the technique 700 finishes (at 730).

If the device is recognized (e.g., the device data is valid and the device 102a is currently online), at 708, a determination is optionally performed of whether the device is currently configured with preferred configuration settings. For example, the configuration service 126 can determine whether the current configuration settings of the device 102a match the preferred configuration settings that have been specified for the device 102a. Operations for performing the determination of whether the configuration settings match (e.g., whether a configuration change has occurred) are also described with respect to stages (H), (I), and (J), (shown in FIG. 2C). If the device is currently configured with preferred configuration settings, the configuration service 126 can log a configuration failure event (at 726), and the technique 700 finishes (at 730).

At 710, configuration data is received. In the present example, the configuration service 126 of the device service platform 120 receives the configuration data 222 for the device 102a. Operations for receiving configuration data are also described with respect to stage (H), (shown in FIG. 2C).

Upon receiving configuration data, a set of configuration settings included in the configuration data can be applied. For example, the configuration service 126 of the device service platform 120 can apply the configuration settings included in the configuration data 222 to the device 102a. Operations for applying configuration settings to a device are also described with respect to stage (K), (shown in FIG. 2C).

In some implementations, a set of configuration settings can be applied to a device sequentially. At 712, for example, the configuration service 126 can perform a determination of whether an unapplied configuration setting exists for the device 102a, and if so, can apply the configuration setting to the device 102a at 714. At 716, if a configuration error occurs while attempting to apply the configuration setting, the configuration service 126 can log a configuration failure event (at 726), and the technique 700 finishes (at 730). If a configuration error does not occur, the technique 700 loops back to 712, where the determination is again performed of whether another unapplied configuration setting exists. If another configuration setting does not exist (e.g., all of the configuration settings have been applied), the technique continues at 718, where the configuration service 126 can log a configuration success event.

In some implementations, one or more additional operations can be performed after applying a set of configuration settings. After applying the configuration settings included in the configuration data 222 to the device 102a, for example, the configuration service 126 can reboot the device 102a (at 720), and can optionally schedule a firmware update (at 724). After the one or more additional operations have been performed, for example, the technique 700 finishes at 730.

Referring again to FIG. 2C, during stage (L), one or more events can be maintained that pertain to the performed configuration operation. For example, configuration event 228 (e.g., a configuration success event or a configuration failure event) can be transmitted to the event data store 130 by the device service platform 120, after attempting to perform the configuration operation 226. The configuration event 228, for example, can optionally include data related to the device, model, switch, location, date/timestamp, success/failure, and other relevant event data. Optionally, additional events related to the configuration operation 226 (e.g., reboot events, reset events, etc.) can also be maintained, with relevant event data and success/failure information. As will be described with respect to FIG. 2D, the event data can be aggregated and analyzed to identify broad actions to be performed with respect to the devices 102a-x of the system 100 (e.g., including the identification of faulty hardware and the formulation of hardware replacement strategies).

Referring to FIG. 2D, operations are shown for analyzing event data of Internet of Things (IoT) devices (cameras and/or other types of devices), and for generating recommended actions based on the data analysis. Through the data analysis and recommended action generation operations, for example, the system 100 can automatically identify patterns in data maintained at the event data store 130 as the data pertains to operations of the devices 102a-x. For example, if a data pattern shows evidence of a particular device, a device model, a switch, and/or a local area network (LAN) being linked to an elevated frequency of device non-responsiveness and/or failure, appropriate actions can be determined to improve the stability and supportability of devices across the network.

During stage (M), event data can be received that pertains to events (e.g., recovery events, configuration events, etc.) that have occurred for various IoT devices. For example, the device service platform 120 can receive event data 230 from the event data store 130. The event data 230, for example, can optionally be a portion of the event data maintained by the event data store 130. In the present example, the event data 230 can include device identifiers, model identifiers, and switch identifiers for events of a particular event type (e.g., recovery events) that occurred at a particular location (e.g., “Location A”). In other examples, more general types of event data (e.g., recovery events across multiple locations, etc.), more specific types of event data (e.g., recovery failure events, recovery success events, etc.), or other types of events (e.g., configuration events, reboot events, reset events, etc.) can be received.

During stage (N), event data can be analyzed. For example, the device service platform 120 can employ the event analysis service 128 (e.g., a centralized service that handles the analysis of event data for various IoT devices across various different locations operating different LANs 152) to perform an analysis operation 232 on the received event data 230. In general, an analysis of event data can be performed using machine learning techniques, or another sort of pattern recognition technique. For example, the event analysis service 128 can maintain a device event machine learning model that is trained using event data received from the event data store 130. As additional event data 230 is received from the event data store 130, for example, the device event machine learning model can be refined by the event analysis service 128, and the service can use the device event machine learning model to identify correlations between particular devices, device models, switches, and/or LANs and the occurrence of particular types of events.

During stage (O), action alerts can be generated for performing a system and/or network reconfiguration. For example, the event analysis service 128 can identify a particular device, device model, switch, or LAN that has a high incidence rate of a particular type of event, and can automatically generate an action alert 234 for rectifying the situation (e.g., repairing or replacing devices, servers, or switches). If a particular device (e.g., device 102a, or “Model A”) has a high incidence rate of particular types of events (e.g., recovery events, reboot events, and/or reset events) relative to other devices of the same model, for example, an action alert can be generated to replace the device. As another example, if a particular device model (e.g., “Model A”) has a high incidence rate of particular types of events relative to other models, an action alert can be generated to phase out the device model in favor of other device models in a device replacement schedule. As another example, if a particular switch (e.g., switch/router 104) is associated with devices having a high incidence rate of particular events relative to other switches, an action alert can be repair or replace the switch. As another example, if devices of a particular LAN (e.g., LAN 152) are experiencing a higher rate of reconfiguration events relative to other LANs, an action alert can be generated to restrict operator access to devices of the LAN, in order to prevent device configuration drift within the LAN. In other examples, a particular combination of factors (e.g., device, device model, switch, and/or LAN) can be identified as leading to a high incidence rate of particular types of events. In the present example, the action alert 234 can be transmitted to a client computing device 290 (e.g., representing a stationary or mobile computing device, such as a personal computer, laptop, personal digital assistant, smartphone, etc.) for presentation by the device 290 (e.g., through a user interface) and for review by an operator of the enterprise networks 150, 152. By generating action alerts based on pattern identification and root cause analysis of device event data, for example, appropriate actions can be taken across an enterprise network to service and manage IoT devices in an effective manner that conserves equipment and resources of the enterprise.

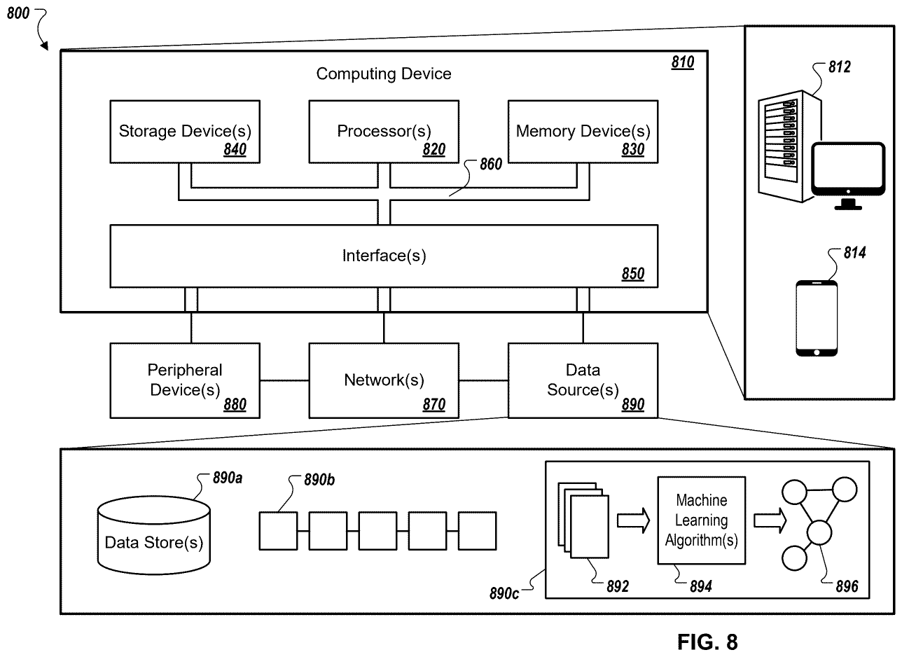

FIG. 8 is a schematic diagram that shows an example of a computing system 800 that can be used to implement the techniques described herein. The computing system 800 includes one or more computing devices (e.g., computing device 810), which can be in wired and/or wireless communication with various peripheral device(s) 880, data source(s) 890, and/or other computing devices (e.g., over network(s) 870). The computing device 810 can represent various forms of stationary computers 812 (e.g., workstations, kiosks, servers, mainframes, edge computing devices, quantum computers, etc.) and mobile computers 814 (e.g., laptops, tablets, mobile phones, personal digital assistants, wearable devices, etc.). In some implementations, the computing device 810 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 810, and an entire system can be made up of multiple devices communicating with each other. For example, the computing device 810 can be part of a computing system that includes a network of computing devices, such as a cloud-based computing system, a computing system in an internal network, or a computing system in another sort of shared network. Processors of the computing device (810) and other computing devices of a computing system can be optimized for different types of operations, secure computing tasks, etc. The components shown herein, and their functions, are meant to be examples, and are not meant to limit implementations of the technology described and/or claimed in this document.

The computing device 810 includes processor(s) 820, memory device(s) 830, storage device(s) 840, and interface(s) 850. Each of the processor(s) 820, the memory device(s) 830, the storage device(s) 840, and the interface(s) 850 are interconnected using a system bus 860. The processor(s) 820 are capable of processing instructions for execution within the computing device 810, and can include one or more single-threaded and/or multi-threaded processors. The processor(s) 820 are capable of processing instructions stored in the memory device(s) 830 and/or on the storage device(s) 840. The memory device(s) 830 can store data within the computing device 810, and can include one or more computer-readable media, volatile memory units, and/or non-volatile memory units. The storage device(s) 840 can provide mass storage for the computing device 810, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 850 can include various communications interfaces (e.g., USB, Near-Field Communication (NFC), Bluetooth, WiFi, Ethernet, wireless Ethernet, etc.) that can be coupled to the network(s) 870, peripheral device(s) 880, and/or data source(s) 890 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 850 can include a control interface that receives commands from an input device (e.g., operated by a user) and converts the commands for submission to the processors 820. The interface(s) 850 can include a display interface that includes circuitry for driving a display to present visual information to a user. The interface(s) 850 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 870 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 810 can communicate with the peripheral device(s) 880, the data source(s) 890, and/or other computing devices over the network(s) 870. In some implementations, the computing device 810 can directly communicate with the peripheral device(s) 880, the data source(s), and/or other computing devices.

The peripheral device(s) 880 can provide input/output operations for the computing device 810. Input devices (e.g., keyboards, pointing devices, touchscreens, microphones, cameras, scanners, sensors, etc.) can provide input to the computing device 810 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 810 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 890 can provide data for use by the computing device 810, and/or can maintain data that has been generated by the computing device 810 and/or other devices (e.g., data collected from sensor devices, data aggregated from various different data repositories, etc.). In some implementations, one or more data sources can be hosted by the computing device 810 (e.g., using the storage device(s) 840). In some implementations, one or more data sources can be hosted by a different computing device. Data can be provided by the data source(s) 890 in response to a request for data from the computing device 810 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 890a (e.g., databases, or other sorts of data management systems). The data store(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 890b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 890c. The machine learning system(s) 890c, for example, can be used to analyze data from various sources (e.g., data provided by the computing device 810, data from the data store(s) 890a, data from the blockchain(s) 890b, and/or data from other data sources), to identify patterns in the data, and to draw inferences from the data patterns. In general, training data 892 can be provided to one or more machine learning algorithms 894, and the machine learning algorithm(s) can generate a machine learning model 896. Execution of the machine learning algorithm(s) can be performed by the computing device 810, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks. With respect to the technology described herein, the training data can include data that represents devices, device models, switches, networks, and events that occur within the networks. The machine learning model that results from the machine learning algorithm(s) can be used to identify correlations between particular devices, device models, switches, and networks, and the occurrence of particular types of events. Use of the machine learning model can provide the benefit of identifying actions and generating action alerts that can mitigate the occurrence of device events while conserving equipment and resources of an enterprise.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer-or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A computer system for automatically monitoring and recovering internet of things (IoT) devices on a network, comprising:
performing an automated heartbeat operation for determining responsiveness of a device over the network;
in response to the automated heartbeat operation resulting in a determination that the device is unresponsive over the network, performing an automated recovery operation of the device, the automated recovery operation comprising:
transmitting a restart command for restarting the device;
after transmitting the restarting command for restarting the device, waiting for a restart period to elapse;
after the restart period has elapsed, automatically performing a test for determining whether the device is operational; and
transmitting, to an event data store, a recovery event that indicates failure or success of the test for determining whether the device is operational.

2. The computer-implemented method of claim 1, wherein the device is a security camera.

3. The computer-implemented method of claim 1, wherein the event data store is an event streaming platform.

4. The computer-implemented method of claim 1, wherein the automated heartbeat operation comprises:
performing a primary heartbeat check of the device over the network;
in response to determining that the device is unresponsive over the network during the primary heartbeat check, starting an unresponsiveness timer for the device;
after starting the unresponsiveness timer, performing at least one secondary heartbeat check of the device over the network; and
in response to (i) determining that the device has remained unresponsive during the at least one secondary heartbeat check, and (ii) determining that the unresponsiveness timer has elapsed, determining that the device is unresponsive over the network.

5. The computer-implemented method of claim 4, wherein performing the at least one secondary heartbeat check comprises performing the secondary heartbeat check in response to determining that the unresponsiveness timer has elapsed.

6. The computer-implemented method of claim 4, wherein performing the at least one secondary heartbeat check comprises periodically performing the secondary heartbeat check while the unresponsiveness timer is running.

7. The computer-implemented method of claim 4, wherein a protocol for performing the primary heartbeat check is a same protocol as a protocol for performing the at least one secondary heartbeat check.

8. The computer-implemented method of claim 4, wherein a protocol for performing the primary heartbeat check is a different protocol from a protocol for performing the at least one secondary heartbeat check.

9. The computer-implemented method of claim 1, further comprising:
after the restart period has elapsed, automatically determining whether a configuration of the device is correct; and
in response to determining that the configuration of the device is incorrect, automatically reconfiguring the device;
wherein the test for determining whether the device is operational is performed after reconfiguring the device.

10. The computer-implemented method of claim 9, wherein determining whether the configuration of the device is correct comprises:
executing a configuration settings collection process that collects current configuration settings of the device;
receiving, from a configuration data store, preferred configuration settings that have been specified for the device; and
comparing the current configuration settings of the device to the preferred configuration settings.

11. The computer-implemented method of claim 10, wherein automatically reconfiguring the device comprises executing a configuration settings application process that applies the preferred configuration settings to the device.

12. The computer-implemented method of claim 1, wherein the device is a security camera, and wherein performing the test for determining whether the device is operational comprises:
interfacing with an application programming interface (API) of the device;
issuing a command via the API to perform a video streaming operation; and
receiving an indication via the API that the video streaming operation was successful.

13. The computer-implemented method of claim 1, wherein the test for determining whether the device is operational results in a determination that the device is non-operational.

14. The computer-implemented method of claim 1, further comprising:
in response to determining that the device is non-operational, determining that a recovery limit for the device has been reached, wherein the recovery event indicates failure of the test for determining whether the device is operational.

15. The computer-implemented method of claim 1, further comprising:
in response to determining that the device is non-operational, determining that a recovery limit for the device had not been reached; and
in response to determining that the recovery limit for the device had not been reached, (i) automatically performing a factory reset of the device, and (ii) automatically reconfiguring the device.

16. The computer-implemented of claim 1, further comprising:
receiving, from the event data store, event data that pertains to a plurality of IoT devices on the network;
using the event data to train a machine learning model; and
based on an output of the machine learning model, generating an action alert for reconfiguring a system that includes the plurality of IoT devices.

17. A computer system for automatically monitoring and recovering internet of things (IoT) devices on a network, comprising:
one or more data processing apparatuses including one or more processors, memory, and storage devices storing instructions that, when executed, cause the one or more processors to perform operations comprising:
performing an automated heartbeat operation for determining responsiveness of a device over the network;
in response to the automated heartbeat operation resulting in a determination that the device is unresponsive over the network, performing an automated recovery operation of the device, the automated recovery operation comprising:
transmitting a restart command for restarting the device;
after transmitting the restarting command for restarting the device, waiting for a restart period to elapse;
after the restart period has elapsed, automatically performing a test for determining whether the device is operational; and
transmitting, to an event data store, a recovery event that indicates failure or success of the test for determining whether the device is operational.

18. The computer system of claim 17, wherein the device is a security camera, and wherein the event data store is an event streaming platform.

19. The computer system of claim 17, wherein performing the test for determining whether the device is operational comprises:
interfacing with an application programming interface (API) of the device;
issuing a command via the API to perform a video streaming operation; and
receiving an indication via the API that the video streaming operation was successful.

20. The computer system of claim 17, the operations further comprising:
receiving, from the event data store, event data that pertains to a plurality of IoT devices on the network;
using the event data to train a machine learning model; and
based on an output of the machine learning model, generating an action alert for reconfiguring a system that includes the plurality of IoT devices.
